(19) United States
(12) Patent Application Publication
(10) Pub. No.: US 2026/0062349 A1
(43) Pub. Date: Mar. 5, 2026

(54) System and Method for Continuous Carbonation of Granular Material

(71) Applicants: Daniel Deocampo, Avondale Estates, GA (US); Richard Jensen, Atlanta, GA (US)

(72) Inventors: Daniel Deocampo, Avondale Estates, GA (US); Richard Jensen, Atlanta, GA (US)

(73) Assignee: Nalari Scientific, LLC, Atlanta, GA (US)

(21) Appl. No.: 19/315,826

(22) Filed: Sep. 1, 2025

Related U.S. Application Data
(60) Provisional application No. 63/689,824, filed on Sep. 2, 2024.

(51) Int. Cl. C04B 20/02; C04B 18/167

(52) U.S. Cl. CPC C04B 20/0232; C04B 18/167

(57) ABSTRACT

A system and method are disclosed for the continuous carbonation of granular concrete under an atmosphere enriched in carbon dioxide. A sealed carbonation chamber cooperates with continuous inflow and outflow valve assemblies to maintain the enriched atmosphere while allowing uninterrupted material transfer. A conveyance mechanism—such as an auger conveyor or helical flights on a rotating chamber wall—advances the granular concrete and promotes exposure to carbon dioxide. Optional features include rotary seals at both inflow and outflow, a carbon dioxide recapture subsystem, and electronic process controls. In certain embodiments the granular concrete exhibits a defined particle size distribution to improve packing and sealing at the valve assemblies. The enriched atmosphere may be derived from an exhaust process. The invention enables industrially scalable processing that improves material properties while permanently mineralizing carbon dioxide.

### CROSS-REFERENCE TO RELATED APPLICATIONS

This application claims the benefit of priority to U.S. Provisional Application No. 63/689,824 filed Sep. 2, 2024, which is incorporated herein by reference.

### FIELD OF THE INVENTION

The present invention relates to systems and methods for treating granular concrete by accelerated carbonation. More particularly, it concerns a continuous processing system employing sealed continuous inflow and outflow valve assemblies and an atmosphere enriched in carbon dioxide to convert reactive phases in granular concrete to stable carbonate phases while maintaining a substantially sealed processing environment.

### BACKGROUND OF THE INVENTION

Construction of concrete pavements and other components of transportation infrastructure depends on large quantities of both fine- and coarse-grained aggregates meeting geotechnical and construction engineering specifications for applications. FHWA estimates the national need of aggregates to be over 600 million tons per year, the majority of which has been met by new mining of natural aggregate resources. Aggregate availability, however, has been declining in recent years, particularly in urban areas and those areas distant from natural geological sources of mineable aggregate. As a result, transportation costs and carbon emissions have been increasing worldwide, and are projected to continue increasing. Aggregates produced by the recycling of obsolete concrete pavements and other structures can provide some portion of the aggregate required. This resource can 1) reduce the need to mine virgin natural aggregates; 2) reduce aggregates transportation costs; 3) divert construction and demolition debris from landfills; and 4) reduce carbon emissions and permanently sequester significant amounts of carbon dioxide as mineralized carbonates. Although numerous states use Recycled Concrete Aggregate (RCA) as roadway base, and some allow its use within limits in new concrete, RCA's broad application in new concrete is limited by high water absorption and low strength. Both of these parameters are well known to improve with carbonation treatment.

Recycled Concrete Aggregate (RCA) is a resource that can be generated through the excavation, crushing, and processing of existing concrete. In its raw form, freshly crushed RCA has several characteristics that make it a poor aggregate for use in formulation of new concrete, including high porosity, low density, high water absorption, and an abundance of reactive calcium hydroxide phases (e.g. portlandite), calcium silicate hydrates (e.g. CSH), ettringite, and other reactive phases. These properties typically limit the use of RCA to base and fill applications that do not require higher performance materials. As aggregates for new concrete, raw RCA is recommended only for limited use, up to 20% replacement depending on the nature of the aggregate, the application, and the jurisdiction.

Extensive research has been conducted to explore options for improving RCA performance, to increase its utility to the circular economy, reduce demand for newly mined natural aggregate, and decrease the environmental impact of pavement construction. Options include addition of supplementary cementitious materials or pozzolanic components, coating with polymer emulsions, pre-hydrating RCA, removal of adhered mortar from aggregate within RCA, heat treatment, carbonation, and others. Much of this work has been promising, but none have been widely deployed in the construction industry, and RCA is still of limited market value.

Carbonation of RCA is effective at reducing the porosity, and therefore water absorption, of RCA, largely through volumetric expansion of reactive phases. This produces substantial improvements in performance of the aggregate in concrete formulation. The principal reactions in carbonation involved are thought to be aqueous dissolution-precipitation reactions of dissociated carbonic acid (H₂CO₃*) with calcium hydroxide (CH; portlandite), calcium silicate hydrate (CSH; tobermorite or similar), and possibly other complex Ca-bearing phases such as calcium alumina ferric oxide sulfate (AFm) and calcium aluminate ferrite (AFt; ettringite), to yield calcium carbonate plus other residual phases.

Carbonation begins with the initial dissolution of gas-phase CO₂ in water. The resulting concentration of aqueous (dissolved) CO₂ is governed by Henry's Law, with higher gaseous CO₂ partial pressures producing higher dissolved CO₂ concentration, initially as carbonic acid (H₂CO₃). Carbonic acid partially dissociates, releasing positively-charged hydrogen ions (H⁺_{(aq)}), and negatively charged bicarbonate (HCO_{3(aq)}⁻), and carbonate (CO_{3(aq)}²⁻), ions. Dissociation is pH-controlled, with full dissociation encouraged by high-pH environments, such as those encountered in concrete pore waters.

The potential phases present in concrete, and hence the potential reactions that may occur with CO₂, are numerous and often poorly characterized. In general, however, the presence of calcium hydroxide and calcium silicate hydrates offer CO₂-reactive phases that mineralize carbon dioxide, precipitate calcium carbonate, and release hydroxide, which in turn interact with hydrogen ions released by carbonic acid to yield water. Although phase compositions may be complex and involve poorly crystalline or amorphous phases, the overall dominant net reactions, incorporating both CO₂ gas dissolution and solid-phase dissolution-precipitation reactions, may be described as follows:

Ca(OH)₂₍ₛ₎+CO_{2(g)}→CaCO₃₍ₛ₎+H₂O₍ₗ₎ Eq. 1

In this case, portlandite within the concrete converts to calcite, absorbing CO₂ and releasing water.

C—S—H+CO_{2(g)}→CaCO₃₍ₛ₎+SiO₂₍ₛ₎+H₂O₍ₗ₎ Eq. 2

In this second case, an amorphous calcium silicate hydrate gel incorporates CO₂ and converts to calcite, while precipitating solid residual silica and releasing water. In both examples of Eqs. 1 and 2, the precise phases and proportions produced are difficult to predict without detailed understanding of the phase composition of the precursor concrete aggregate. However, the overall net effects have been well demonstrated that calcium carbonate is quantitatively produced by carbonation, containing mineralized CO₂ originating from the gas phase.

The degree of hydration of RCA has been shown to be a critical parameter in the effectiveness of carbonation. In the extreme, complete immersion in water allows the reaction to proceed to conclusion; this requires a lot of water, however, as well as a mechanism for rapid dissolution of CO₂ in that large volume. “Dry carbonation” has been widely demonstrated, in which partially-hydrated aggregates are exposed to a high CO₂ atmosphere, with some amount of water vapor present. Under these conditions, the degree of carbonation is sensitive to the hydration degree of the aggregate. Sereng et al. (2021), for example, showed in the FastCarb project that CO₂ uptake rates rose from ˜30 kg/ton to ˜50 kg/ton at optimal hydration (˜5% for coarse aggregate). This was interpreted as representing poor access of CO₂ to mineral surfaces without facilitating water, whereas too much water slows CO₂ diffusion.

Although it is difficult to precisely control hydration, the extremes of dryness and flooded wetness can be avoided. Several parameters have been shown to be improved in RCA by carbonation that improve the outcomes of concrete manufacture. These include a reduction in porosity, water absorption coefficient, and strength increases. The major reaction driving performance improvement by carbonation is the replacement of hydroxide or hydrate species with carbonate species. Calcium carbonate is commonly a pore-filling combination of lower WAC and higher rigidity combine to produce improvements in standard concrete performance tests, including greater workability as shown on slump tests, as well as greater compressive strengths as shown on standard concrete tests. The lowered porosity and permeability is also thought to improve the resistance to chloride intrusion, thus leading to longer functional life of concrete.

Natural carbonation of concrete in the ambient environment has long been known to occur in concrete structures, and has been cited as a contributing factor in the survival of ancient concrete structures. Natural carbonation is slow, however, and is generally restricted to the surface zone of exposure, and it is known to increase the risk of rebar corrosion. In order to be industrially useful for transportation infrastructure, carbonation must be accelerated to rates faster than the rates common in ambient environments. Accelerated carbonation of RCA has been well studied and documented in the lab. These studies have generally been at a bench scale, with batch reactions of aggregate, and variable configurations of atmospheres and hydration. All of these laboratory demonstrations show the feasibility and efficacy of strengthening RCA and sequestering CO₂ through RCA carbonation. However, most demonstration chambers have been of modest size, and lacked aggregate inflow and outflow to demonstrate throughflow potential calibrated to CO₂ gas content and environmental conditions in the reaction chambers.

Although all of these studies, and others, clearly demonstrated the ability of reactors to facilitate the RCA carbonation reactions, only FastCarb demonstrated industrial scale production capacity. Despite how well understood RCA carbonation is, and despite the above examples of proven RCA carbonation methods, no industrial deployment of RCA carbonation has yet been achieved in the US. The inventors have identified two significant risks to the technology preventing deployment, that are targeted by this invention: the mechanism of aggregate introduction and removal from the reaction chamber, and the conservation of CO₂ gas. The means of aggregate conveyance needs to achieve desired industrial levels of throughput, without clogging and with little maintenance, while preserving the reaction chamber's atmosphere without importing ambient atmosphere or allowing CO₂ loss. Gas losses out of the reaction chamber for the FastCarb project were returned to the kiln flue gas stream, simplifying FastCarb's need for vapor loss control. If captured/stored gases are used, however, which will be likely in many use case scenarios, then release may not be permitted. Moreover, a continuous feed, rather than the batch reactions that have been proven, can have the advantage of longer production runtimes and greater efficiency.

Analysis of the economic and environmental impacts of RCA Carbonation as a replacement for some portion of natural aggregate in transportation infrastructure construction requires consideration of many factors that vary by scenario. One of the controlling factors is the proximity of concrete batching plants to mineable natural aggregate sources, as this controls both the costs and carbon emissions of aggregate transport.

In determining the reduction or increase in economic or environmental costs by replacing natural aggregates with carbonated RCA, some costs are common to both approaches, and some are unique to each. Assessment of these costs depends primarily on transport distances and commercial prices. Those costs unique to RCA implementation are more difficult to assess given the lack of current industrial implementation of RCA in pavement construction, as they are sensitive to different scenarios. For example, FastCarb was implemented at cement kilns, relying on kiln flue gas as a CO₂ source. This is not a feasible widespread source of CO₂ in the US, however, as the US only has about 100 cement kilns currently operating. In comparison, over 15,000 concrete batching plants are in operation. It may be more feasible to anticipate distribution of CO₂ for RCA carbonation by industrial carbon capture operations that are able to distribute it. As of 2023, 15 carbon capture units in the US currently have capacity to capture 22Mt of CO₂ per year, most of which currently goes to use in the oil industry for enhanced oil recovery. This stream of CO₂ is an abundant resource that can potentially be used for RCA carbonation.

Although any analysis will have significant uncertainties, several life cycle economic and environmental studies have shown that transport distances between key facilities and the construction site or batch plant are controlling factors in comparing the use of mined natural aggregates versus RCA. For the geographically diverse national market, therefore, it will be critical to map and understand these distances to reliably model economic and environmental costs. Those regions of the nation containing abundant natural aggregate sources may therefore find that natural aggregates continue to be lower cost. Those regions of the nation with limited natural aggregate sources, however, as well as urban areas, are likely candidates for both economic and environmental benefit for replacing natural aggregates with RCA. These areas, identified by the U.S. Geological Survey, include the Coastal Plain, the Mississippi Embayment, the Colorado Plateau, the glaciated Midwest, the High Plains, and the non-glaciated Northern Plains, as well as major metropolitan urban areas.

In addition to the foregoing, the logistics of transporting aggregate and recycled materials over long distances contribute to embedded energy and emissions. Deploying carbonation proximate to demolition or recycling sites reduces haulage and enables closed-loop utilization of construction materials. Further, carbonation of granular concrete produces calcium carbonate deposits that densify pore structure, thereby reducing water absorption and improving freeze-thaw durability and abrasion resistance.

Conventional laboratory and pilot approaches have largely relied on batch operations that require repeated pressurization and depressurization cycles, opening and closing of chambers, and manual handling. These actions incur gas losses and operational downtime. A continuous system with sealed inflow and outflow pathways addresses these inefficiencies and is better suited to industrial throughput.

### SUMMARY OF THE INVENTION

The invention provides a system, method, and device for the continuous carbonation of granular concrete under an atmosphere enriched in carbon dioxide. The system comprises a sealed carbonation chamber, a continuous inflow valve assembly, a continuous outflow valve assembly, and a conveyance mechanism disposed within the chamber. The continuous inflow and outflow assemblies maintain the enriched atmosphere while allowing uninterrupted transfer of granular material into and out of the chamber. Unlike existing batch reactors, the invention uses sealed continuous auger valves to prevent CO₂ loss. In certain embodiments, the conveyance mechanism comprises at least one auger conveyor disposed within the chamber. In other embodiments, the conveyance mechanism comprises helical flights affixed to an interior surface of the chamber such that rotation of the chamber advances the granular concrete. Mixing features situated between flights may redistribute and disaggregate the granular concrete to enhance reaction efficiency. Rotary seals may couple the chamber to both the inflow and outflow valve assemblies to maintain sealing integrity while allowing for chamber rotation. In further embodiments, a carbon dioxide recapture subsystem recovers gas from void spaces surrounding discharged granular material and returns the recovered gas to the carbonation chamber. The enriched atmosphere may be derived from an exhaust process. In certain embodiments, the granular concrete introduced into the chamber exhibits a particle size distribution that consists essentially of multiple defined size ranges measured by weight percent, which improves packing density, flow uniformity, and sealing performance at the continuous valve assemblies. Electronic control systems may regulate chamber rotation, residence time, carbon dioxide concentration, humidity, and temperature to achieve desired levels of carbonation.

### BRIEF DESCRIPTION OF THE DRAWINGS

FIG. 1. An inflow hopper 1 to convey the RCA into the carbonation chamber 5 via the inflow auger valve system 2, which is connected to the carbonation chamber by a rotary seal 4. The auger valve system is driven by a motor 9. The carbonation chamber is rotated by a motor 25 and contains helical flights 6 to move the RCA contained between the flights 21 towards the rotary cone hopper 7 and outflow auger valve system 8 driven by a motor 9. The chamber also contains topological disturbances 22 for mixing the RCA as the chamber rotates. The outflow auger valve system contains a hollow auger-valve shaft 17 for CO₂ inflow into chamber and a CO₂ inflow valve 18 at the end of the shaft inside the chamber. A hose 12 connects the CO₂ tank 11 to the hollow auger-valve shaft via a rotary seal gas valve 19.

FIG. 2. An inflow hopper 1 feeds the RCA to the inflow auger valve 2, which is driven by a motor 9, into a non-rotary inflow chute 3. The inflow chute is connects to the rotary carbonation chamber 5 by a rotary seal 4. The carbonation chamber features helical auger-conveyor flights 6 affixed to an inner auger support stem 13. The chamber is rotated by a motor 25, which moves the RCA towards the non-rotary outflow chute 14, which forms into the outflow hopper 7, containing the outflow auger valve system 8 at the bottom, which is also driven by a motor 9. The system also features a gas input connector valve 10, connected to a gas hose 12 and a CO₂ tank 11. Finally, the system may contain a CO₂ scrubbing system 23.

FIG. 3. An inflow hopper 1 and inflow auger valve system 2, conveying aggregate into a stationary carbonation chamber 100. Method of conveyance within the chamber 105 moves aggregate through the chamber, such as conveyor belt, screw conveyor, or other means, and may constitute a circuitous back and forth path, until it exits through the outflow auger valve system 110. The system also features a gas input connector valve 10, connected to a gas hose 12 and a CO₂ tank 11. Gravitational piling of aggregate 115, which may or may not be assisted by mechanical compression, reduces gas permeability of the matrix.

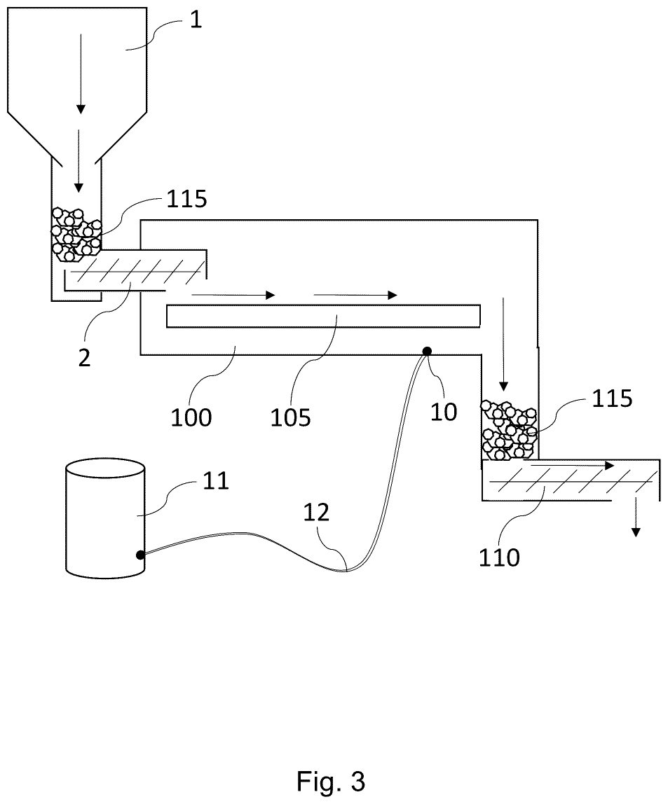

### DETAILED DESCRIPTION OF THE INVENTION

The invention described here is for a system and method for the continuous processing and carbonation of recycled concrete aggregate (RCA) and other forms of granular concrete under a sealed atmosphere. This system may also be used for the processing of other granular materials in similar ways under an atmosphere. Most anticipated embodiments of this invention feature a processing and carbonation chamber 5, through which the RCA is moved, that is substantially sealed from the external atmosphere. This chamber 5 will generally contain a CO₂ atmosphere with valves 10 or similar connections for the circulation and regulation of CO₂ in the chamber 5. The chamber 5 will also feature a means for the continuous inflow 2 of RCA into the chamber and outflow of RCA from the chamber 8, comprising continuous inflow auger valves, as described in U.S. Ser. No. 18/811,064, a prior patent application filed by the same inventors, which is incorporated herein by reference.

In certain embodiments, the atmosphere enriched in carbon dioxide includes substantially pure carbon dioxide as well as gas mixtures in which carbon dioxide is present at a concentration greater than ambient air, including exhaust and recycled process gases. In most embodiments, the system accommodates gas introduction through dedicated inlet ports 10 connected to an external carbon dioxide system 11 or source.

In one set of embodiments, the invention has a stationary chamber 100 containing one or more auger conveyors 105, situated in parallel or series, to convey the granular concrete from the inlet valve 2 to the outlet hopper 7 and valve 8.

In another set of embodiments of this invention, the chamber 5 is an elongated cylinder fitted with helical flights 6 on the inside such that as the chamber 5 rotates it will convey the RCA from one end of the chamber 5 to the other. These embodiments having a rotary conveyance chamber 5 may have various topological features 22 situated between the helical flights 6 along the travel path of the RCA through the chamber 5 in order to mix the and redistribute the RCA as it travels through the chamber 5. These topological features 22 may include bars, bumps, fins, knobs, channels, or any other similarly situated geometries that disrupt the otherwise smooth surface of the chamber wall between the helical flights 6.

The chamber 5 and the various components may be made of any material that is durable enough to withstand the continuous contact with moving RCA. Non-limiting examples are steel, steel alloys, other metals and metal alloys, ceramics, carbon fiber, composite materials, high-density plastics, and others known to those skilled in the art.

Most embodiments of the invention feature a hopper to contain the RCA prior to inflow into the chamber. The bottom of this hopper features the end of an auger extending from the continuous inflow auger valve system, as described in the previous patent by the inventors cited above. For more detailed information on this portion of the invention, see that patent.

The continuous inflow auger valve system allows a sealed atmosphere to be contained within the chamber while also continuously depositing the RCA into the chamber. The same system is used for the outflow of RCA from the chamber after processing.

In preferred embodiments, the granular concrete introduced into the chamber has a particle size distribution consisting essentially of: from 0.1 wt % to 30 wt % of particles less than 75 micrometers; from 0.1 wt % to 30 wt % of particles from 75 micrometers to 150 micrometers; from 5 wt % to 80 wt % of particles from 150 micrometers to 4 millimeters; from 5 wt % to 50 wt % of particles from 4 millimeters to 19 millimeters; and from 5 wt % to 50 wt % of particles from 19 millimeters to 38 millimeters; each percentage being by weight based on the total weight of the granular concrete and the recited weight fractions collectively totaling 100 wt %. This distribution occupies interstitial voids and reduces gas permeability at the continuous valve assemblies while maintaining bulk flowability.

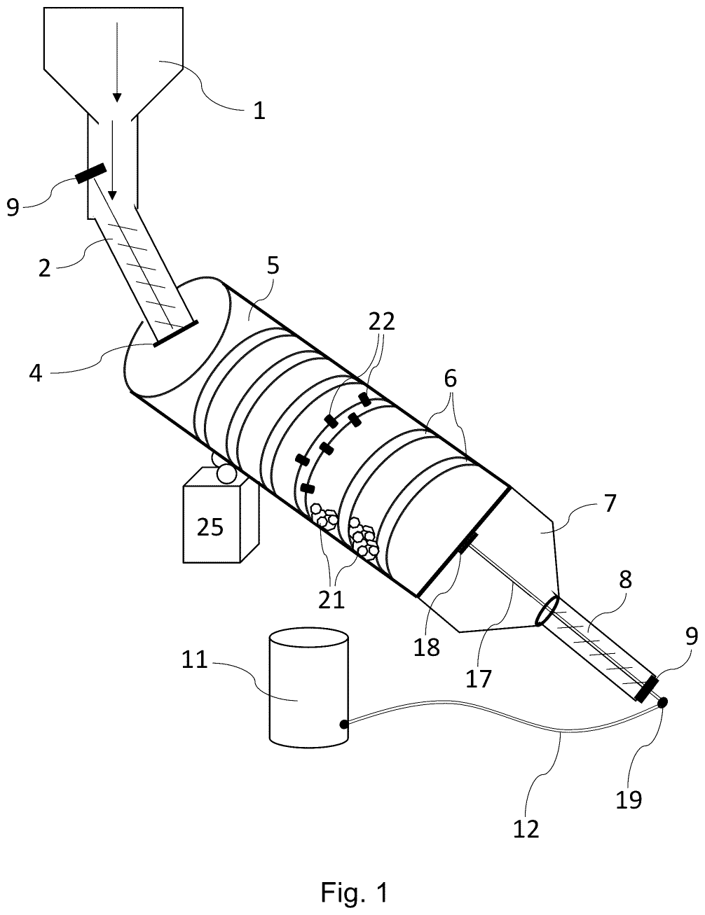

For the inflow system, the chamber may be connected to the smallest cylinder containing the continuous inflow auger valve system 2 by a rotary seal 4, which utilizes rotary seal technology commonly known to those skilled in the art in order to maintain a sealed environment between the chamber 5 and the auger valve system 2, which connects the hopper 3 to the chamber 5. An example of this may be seen in FIG. 1.

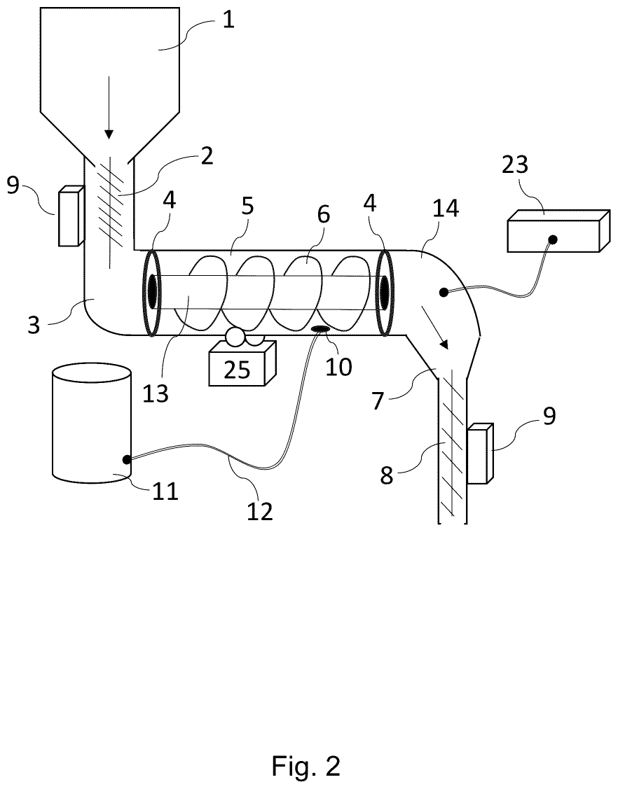

In other embodiments, such as those depicted in FIG. 2, the system may feature a larger, non-rotary, entry chute 3 connecting the rotating chamber 5 to the inflow auger valve 2. This non-rotary chute 3 connects to the chamber through a rotary seal 22 and allows the chamber 5 to rotate independently of the chute 3.

In some embodiments, a series of chambers 5 may be connected by successive chutes or hopper and valve systems to form a continuous, multi-chamber processing system for processing larger volumes of RCA or for having different atmospheric conditions or processing methods used in the separate chambers in the multi-chamber system.

The rotary speed of the chamber 5 will depend on the desired residence time of the RCA within the chamber 5 and the number of helical turns of the flights 6 in the chamber. This can be controlled by a motor 25 and a computer, which may also act as a central processing unit to control many other features of the system.

Once the RCA reaches the end of the chamber 5, it will be deposited into an outflow hopper 7. In embodiments such as depicted in FIGS. 2, the hopper 7 may be at the bottom of a non-rotary chute 14, similar to the inflow chute 3, and it will contain a continuous outflow auger valve system 8 at the bottom of the hopper 7 to continuously remove the processed RCA from the system while maintaining a sealed environment. In embodiments, such as that depicted in FIG. 1, the chamber 5 is tilted at an angle and the bottom of the rotary chamber 5 is formed into a conical shape which serves as the outflow hopper 7, with the continuous outflow auger valve system 8 exiting the chamber from the center of the cone. This conical outflow hopper 7 rotates with the chamber 5, so the angle of the chamber 5 and the level of the RCA within the conical hopper 7 must be such that the RCA is over the centerline into which the outflow auger valve system 8 extends. In these embodiments, the CO₂ may enter the chamber through a pipe created within or fitted within the central auger shaft of either the continuous inflow auger valve system 2 or the continuous outflow auger valve system 8, such as that shown in FIG. 1.

Each of these embodiments may also contain a system for recapturing CO₂ that may be contained in the void spaces between the outflowing RCA. This system may involve the use of a sealed CO₂ recapture chamber into which the RCA is deposited by a continuous flow auger valve system 8 before exiting the system. In that recapture chamber, the air may be removed by an air pump 24 that circulates the air in the chamber through a CO₂ scrubbing system 23 to remove excess CO₂ prior to pumping it out into the environment or back into the CO₂ recapture chamber. In some embodiments the air in the recapture chamber may be replaced in the chamber with external air from an external air pump 24. The captured CO₂ may be put back into the carbonation chamber 5 as the system regenerates the scrubbing system. The bottom of the recapture chamber may form a hopper 7 for the outflow of the RCA through an outflow auger valve system 8. Any CO₂ scrubbing technology may be used in this system. These technologies are commonly know to those skilled in the art.

In some embodiments, one or more size fractions of the granular material may be recirculated from the outflow valve 8, back to the inflow hopper 1 and inflow valve assembly 2. The size fractions may include either or both fine and coarse grain materials, and may even be an inert material that is non-creative with carbon dioxide so that it does not interfere with the carbonation process. This serves to maintain a specific grain size distribution in the valve assemblies so that an optimal seal can be achieved in the chamber 5.

A control unit may regulate chamber rotation, auger speeds, gas flow, carbon dioxide concentration, humidity, and temperature. Sensors placed along the chamber may provide feedback for adaptive control of residence time and carbonation progression. The system may operate continuously over extended intervals, thereby minimizing start-stop losses and improving overall gas utilization efficiency.

In certain embodiments, the carbonation chamber is operated under CO₂ concentrations between 3-20% CO₂ by volume, 20-50% CO₂ by volume, or 50-100% CO₂ by volume, and relative humidity between 30-80%. In a preferred embodiment, carbonation yields between 1-50 kg CO₂ uptake per ton of RCA.

This system allows for the continuous processing of the RCA under a CO₂ atmosphere with a minimal and simplified set of moving parts. In some embodiments, the rotation of the chamber may be achieved with a low powered motor and that very same rotation also moves the RCA through the system. The rotation, when combined with the topological features for mixing and redistributing the RCA, may also help disaggregate the RCA and remove layers as they carbonate, thus allowing for further carbonation of the inner layers that become exposed, which may be ideal for some uses. This may also be accomplished by the use of the non-rotating chamber using one or more auger-conveyors to transport the RCA or other granular material from the inflow valve to the outflow hopper.

What is claimed:

1. A system for carbonation of granular concrete, comprising:
(a) a sealed carbonation chamber configured to contain an atmosphere enriched in carbon dioxide;
(b) a continuous inflow valve assembly configured to introduce granular concrete into the chamber while maintaining the enriched atmosphere;
(c) a continuous outflow valve assembly configured to discharge granular concrete from the chamber while maintaining the enriched atmosphere; and
(d) a conveyance mechanism disposed within the chamber and configured to advance the granular concrete through the chamber under the enriched atmosphere.

2. The system of claim 1, wherein the inflow valve assembly and the outflow valve assembly each comprise an auger valve configured to transport granular concrete while limiting gas leakage.

3. The system of claim 1, wherein the conveyance mechanism comprises at least one auger conveyor disposed within the chamber.

4. The system of claim 1, wherein the conveyance mechanism comprises helical flights affixed to an interior surface of the chamber and configured to advance the granular concrete upon rotation of the chamber.

5. The system of claim 1, further comprising rotary seals coupling the chamber to the inflow valve assembly and the outflow valve assembly, the rotary seals maintaining the enriched atmosphere during rotation of the chamber.

6. The system of claim 1, further comprising a carbon dioxide recapture subsystem configured to recover carbon dioxide entrained with granular concrete discharged through the outflow valve assembly and to return recovered carbon dioxide to the chamber.

7. The system of claim 1, further comprising a control unit configured to regulate chamber rotation, granular concrete residence time, carbon dioxide concentration, and carbon dioxide flow.

8. The system of claim 1, wherein the granular concrete introduced into the chamber has a particle size distribution consisting essentially of:
(i) from 0.1 wt % to 30 wt % of particles having a size less than 75 micrometers;
(ii) from 0.1 wt % to 30 wt % of particles having a size from 75 micrometers to 150 micrometers;
(iii) from 5 wt % to 80 wt % of particles having a size from 150 micrometers to 4 millimeters;
(iv) from 5 wt % to 50 wt % of particles having a size from 4 millimeters to 19 millimeters; and
(v) from 5 wt % to 50 wt % of particles having a size from 19 millimeters to 38 millimeters;
each percentage being by weight based on the total weight of the granular concrete, the recited weight fractions collectively totaling 100 wt %.

9. The system of claim 1, wherein at least one size fraction of the granular concrete is recycled from the continuous outflow valve assembly back to the continuous inflow valve assembly in order to maintain the desired grain size distribution within the system.

10. The system of claim 1, wherein the atmosphere enriched in carbon dioxide within the chamber is derived from an exhaust process.

11. A method of carbonating granular concrete, comprising:
(a) introducing granular concrete into a sealed carbonation chamber through a continuous inflow valve assembly while maintaining an atmosphere enriched in carbon dioxide within the chamber;
(b) advancing the granular concrete through the chamber under the enriched atmosphere by operation of a conveyance mechanism disposed within the chamber;
(c) exposing the granular concrete to the enriched atmosphere within the chamber to effect carbonation; and
(d) discharging carbonated granular concrete from the chamber through a continuous outflow valve assembly while maintaining the enriched atmosphere within the chamber.

12. The method of claim 11, further comprising using auger valves for the continuous inflow valve assembly and the continuous outflow valve assembly.

13. The method of claim 11, further comprising using at least one auger conveyor as the conveyance mechanism disposed within the chamber.

14. The method of claim 11, further comprising advancing the granular concrete by rotating the chamber and having helical flights affixed to an interior surface thereof.

15. The method of claim 14, further comprising redistributing and disaggregating the granular concrete by interaction with topological mixing features disposed between the helical flights.

16. The method of claim 11, further comprising recovering carbon dioxide entrained with the discharged granular concrete and returning recovered carbon dioxide to the sealed carbonation chamber.

17. The method of claim 11, further comprising regulating chamber rotation, granular concrete residence time, carbon dioxide concentration, and carbon dioxide flow with a control unit during operation.

18. The method of claim 11, further comprising introducing granular concrete into the chamber having a particle size distribution consisting essentially of:
(i) from 0.1 wt % to 30 wt % of particles less than 75 micrometers;
(ii) from 0.1 wt % to 30 wt % of particles from 75 micrometers to 150 micrometers;
(iii) from 5 wt % to 80 wt % of particles from 150 micrometers to 4 millimeters;
(iv) from 5 wt % to 50 wt % of particles from 4 millimeters to 19 millimeters; and
(v) from 5 wt % to 50 wt % of particles from 19 millimeters to 38 millimeters;
each percentage being by weight based on the total weight of the granular concrete, the recited weight fractions collectively totaling 100 wt %.

19. The method of claim 11, further comprising using an atmosphere enriched in carbon dioxide within the chamber that is derived from an exhaust process.

20. The method of claim 11, further comprising recycling at least one size fraction of the granular concrete from the continuous outflow valve assembly back to the continuous inflow valve assembly in order to maintain the desired grain size distribution within the system.
